(19) United States
(12) Patent Application Publication
(10) Pub. No.: US 2011/0166882 A1
(43) Pub. Date: Jul. 7, 2011

(54) BUSINESS METHOD FOR HAIR REPLACEMENT AND MAINTENANCE

(76) Inventor: CESARE RAGAZZI, Zola Predosa (Bologna) (IT)

(21) Appl. No.: 12/743,520

(22) PCT Filed: Jul. 20, 2007
(86) PCT No.: PCT/IB2007/003325

§ 371 Date: May 18, 2010

(51) Int. Cl. G06Q 50/00

(52) U.S. Cl. 705/3

(57) ABSTRACT

The quality of hair maintenance and replacement services in commercial personal grooming service companies provided by an organization to a customer is assured. Initial multiphasic assessment with progressive reviews and client input and acceptance of a mutually derived solution is performed, undertaken and measured. Episodic client assurance reviews, assessment of mutually designated outcome metrics and collective modifications are made to heighten client commitment, satisfaction and quality assurance. Process and final deliverable reviews are performed to assure customer need satisfaction. The invention is a method comprised of an array of multiple comprehensive steps individualized to the specific characteristics of the client with their completion measured, reported and agreed upon to assure consistent and acceptable quality levels.

### BACKGROUND OF THE INVENTION

The present invention relates to business methods for assuring quality services that providers and clients will comply with and particularly to delivering consistent and reproducible hair maintenance and replacement services which have a high quality assurance level in a multi-location commercial business enterprise.

Providing hair maintenance and replacement services have become an important part of the commercial personal grooming industry.

Commercial personal grooming companies recognize that having high quality hair maintenance and replacement services are essential to successfully operating their businesses in a competitive environment. Numerous grooming service providers compete for clients so it is essential that assessing, formulating, and delivering these services be provided in a consistently and assured high quality manner to support client compliance, satisfaction and repeated business service transactions.

Business methods, practices and quality techniques have been developed and applied in manufacturing (Tucker et al. U.S. Pat. No. 5,432,218), flow and development monitoring systems (Keane U.S. Pat. No. 5,737,581 and Turnbull U.S. Pat. No. 5,208,765), image processing (Stapleton U.S. Pat. No. 5,537,483), healthcare (Ertel U.S. Pat. No. 5,307,262), and information technology (Gloor et al. U.S. Pat. No. 7,136,823). None of these inventions apply to assuring the quality of solutions in the commercial personal grooming service industry, particularly in hair maintenance and replacement.

### SUMMARY OF THE INVENTION

The term “Bicast” as used herein means a piece made from an impression of a skull area for hair replacement.

The term “Calco” as used herein means a piece made from an impression of a skull of a client.

The term “Epithesis” as used herein means a hair replacement piece fabricated from a Bicast, a Calco, hair, and other elements.

The term “Tricosil™ product line” as used herein means those topical beauty products used both at home and in the salon including hair care preparations, such as hair cleaners, shampoos, conditioners, lotions, hair sprays, hair styling mousses, hairpiece cleaners, essential oils, and cosmetic products, available from Cesare Ragazzi Company, S.p.A., combined with select treatment modalities such as massage, steam/ozone, laser light therapy (personal and professional), electro-static pulse; as required by the condition, treatment/efficacy/benefit and client directives.

The term “treatment modalitities” as used herein means active procedural therapeutic interventions with commercially marketed modalities.

The term “Tricotest™” as used herein means a computerized system and software available from Cesare Ragazzi Company, S.p.A. for use in assessing a person's hair characteristics, which performs a computerized systematic measure of the color, character, health, density, wave and style of the client, as well as levels of sebum, hydration and pH.

The present invention provides a business method for providing quality services which providers and clients will comply with and deliver consistent and reproducible hair maintenance and/or replacement services, comprising the steps of: conducting a hair maintenance and/or replacement marketing program; first assessing a client, who has responded to said marketing program, using a computerized system which measures color, character, health, density, wave and style of the client's hair and scalp as well as level of sebum. hydration, and pH; reviewing results of said computerized system assessing step; first consulting with the client and recommending a treatment plan including type of treatment, duration, intensity, and frequency selected; first treating the client's hair and scalp with procedures selected from a group comprising topical therapies, massage, steam/ozone, laser/light, and pulsed electrical field stimulation; preparing a client assurance review and decision record; first interim evaluating results and quality; first reviewing progress with client, stylist, and technician; continuing or modifying said treatment plan as necessary; second assessing of the client using said computerized system which measures color, character, health, density, wave and style of the client's hair and scalp as well as level of sebum. hydration, and pH; reviewing results of the computerized system second assessing step; planning ongoing program of either styling only, styling and hair maintenance, or hair maintenance and replacement program; second consulting with the client and recommending a further treatment plan including type of treatment, duration, intensity, and frequency selected; and second treating the client's hair and scalp with procedures selected from a group comprising topical therapies, massage, steam/ozone, laser/light, and pulsed electrical field stimulation.

The invention also provides a comprehensive method of maintenance and/or replacement of a client's hair, comprising the steps of: evaluating general health, specific diagnoses and conditions, medications, nutrition status, condition of scalp and cutis, personal and family medical history, grooming practices, and products and processes used by the client; ascertaining grooming services history of cutting, treatments, products and practices used by the client; maintaining, enhancing, preparing, and optimizing the client's scalp and remaining hair; replacing hair, if agreed upon by the client, to meet specific, styling, lifestyle and preferences of the client; and performing maintenance of the replacement system.

The invention also provides a comprehensive method of maintenance and/or replacement of a client's hair, comprising the steps of: assessing general health, specific diagnoses and conditions, medications, nutrition status, condition of scalp and cutis, personal and family medical history, grooming practices, and products and processes used by the client; ascertaining grooming services history of cutting, treatments, products and practices used by the client; maintaining, enhancing, and optimizing the client's remaining hair; and replacing hair, if agreed upon by the client, to meet specific, styling, lifestyle and preferences of the person.

An object of the invention to include the steps of beginning the hair replacement program with detailed assessing of immediate or gradual hair replacement, length and style goals, and assessing by physician; measuring for a Bicast and a Calco; sending the Bicast and Calco measurements to a production facility with work order and contract; and continuing maintenance program to substantially coincide with completion of an Epithesis for the client.

Another object is to include the steps of: updating the client assurance review and decision record; second interim evaluating results and quality; second reviewing progress with client, stylist, and technician; continuing or modifying the treatment plan as necessary; delivering the Epithesis and applying it to the client; scheduling Epithesis service for every three weeks as the client reviews progress with stylist and technician; and continuing or modifying the treatment plan as necessary.

A further object is to include the step of photostimulating the client's scalp.

Yet another object is to have the photostimulating step include pulsed emission of beams of light in red and violet spectrums.

An additional object is to provide the pulsed emission of beams of light in the red spectrum to enhance microcirculation; and the pulsed emission of beams of light in the violet spectrum to promotes reduction of bacterial load.

A further object is to have the step of photostimulating the person's scalp performed by means of a dual spectrum, high intensity light beam generated by a matrix of a plurality of LEDs.

Another object is maintaining, enhancing, preparing, and optimizing the client's scalp and remaining hair including one or more treatments selected from a group comprising massage, steam/ozone therapy, electrostatic treatment, and photostimulation.

Yet a further object is having the evaluating step also include measuring hydration, sebum, pH, hair shaft thickness, hair density (number of hairs per square centimeter), hair shaft keratin content, scalp condition, dandruff, and inflammation.

Another object is having steam/ozone therapy comprise a stand-alone modality which promotes absorption of oils, dandruff remedies, and a TricosilTM product line, circulation, and restores a balance of natural flora.

A further object is having the step of performing maintenance of the replacement system include hair maintenance treatment with predetermined products which promote scalp health and hair thickness; and the predetermined products comprise oils, dandruff remedies, and a Tricosil™ product line.

Another object is to include the steps of: measuring the client's hair replacement area in proportion to the client's face shape, length and width; using casting materials to fabricate a Bicast mold of the hair replacement area which is where an Epithesis for the client is placed; and using a mold of the client's entire skull to support style, overall design, and provide a portable head to place hair pieces on.

A further object is having the Epithesis fabricated by a custom application which includes strand-by-strand placement, predetermined angles of each placement, predetermined density of the placement, and a predetermined pattern of the placement.

Yet another object is to provide method wherein the hair replacing step comprises substeps of: analyzing the person's cutis; mapping the person's hair wave, density, whorl, pattern, streams, flexibility (twists, curls, and/or knots), texture touch and color gradations; defining an area or areas to be replaced; selecting a rate of replacement; selecting multiple colors of natural culturally-indigenous hair to populate the area or areas to be replaced; and populating hair into the area or areas to be replaced strand by strand to match characteristics found in the mapping sub-step.

Other objects, advantages, and features of the invention will become apparent to those persons skilled in this particular area of technology and to other persons after having been exposed to this patent application when read in conjunction with the accompanying drawings and photographs because black and white line drawings are insufficient to adequately disclose the subject matter for which patent protection is being sought, and to provide an adequate disclosure.

### BRIEF DESCRIPTION OF THE DRAWINGS

FIG. 1 is a photograph of the items received from the salon at the production facility for each client according to the invention.

FIG. 2 is a photograph showing the Bicast outlined in the Calco.

FIG. 3 is a photograph showing the Calco being read for transfer to a positive.

FIG. 4 is a photograph showing the positive being made from dense foam.

FIG. 5 is a photograph showing the completed positive head molds with the Bicast outlined.

FIG. 6 is a photograph showing hair colors and percentage of gray.

FIG. 7 is a photograph showing newly received hair sorted by color.

FIG. 8 is a photograph showing various waviness in a color.

FIG. 9 is a photograph showing showing hair sorted by separating lengths in each bundle.

FIG. 10 is a photograph showing various lengths from a single bundle.

FIG. 11 is a photograph showing the Bicast becoming the Epithesis.

FIG. 12 is a photograph showing correct versus incorrect hair directionality.

FIG. 13 is a photograph showing hair sort and first row alignment.

FIG. 14 is a photograph showing how the first row margin placement is critical and managed with precision.

FIG. 15 is a photograph showing an additional layer of base.

FIG. 16 is a photograph showing the client's personal hair plot.

FIG. 17 is a photograph showing the action of individual hair strand placement.

FIG. 18 is a photograph showing various stages of building.

FIG. 19 is a photograph showing the action of trimming.

FIG. 20 is a photograph showing securing the inner layers.

FIG. 21 is a photograph showing removal of the outer layer to promote fit and conformity.

FIG. 22 is a photograph showing internal coating and finishing.

FIG. 23 is a photograph showing micro perforations are made to ensure and maintain scalp health and comfort.

FIG. 24 is a photograph showing final touchup and inspection.

FIG. 25 is a photograph showing the Tricotest™ computer system.

FIG. 26 is a photograph showing actual client hair photos.

FIG. 27 is a photograph showing actual client scalp fotos.

FIG. 28 is a photograph showing measurement of the shape and features of the face are made.

FIG. 29 is a photograph showing the plastic wrap.

FIG. 30 is a photograph showing the plastic wrap tightly pulled.

FIG. 31 is a photograph showing area to be replaced is marked.

FIG. 32 is a photograph showing fiber form wrap is placed.

FIG. 33 is a photograph showing form is molded to skull and replacement area is transferred to skull.

FIG. 34 is a photograph showing finished form is cut-out and sizing is confirmed.

FIG. 35 is a photograph showing the Calco wrap is placed.

FIG. 36 is a photograph showing the mold is form fit and cured.

FIG. 37 is a photograph showing the form is trimmed and finished, ready for shipping to the production facility.

FIG. 38 is a photograph showing the Vapoozono™ device.

FIG. 39 is a photograph showing the Tricopulse™ Special device.

FIG. 40 is a photograph showing the Tricopulse™ Professional device.

FIG. 41 is a photograph showing the Tricopulse™ ETG device.

FIG. 42 is a photograph showing the Tricopress™ Plus device.

FIG. 43 is an overall process flowchart.

### DETAILED DESCRIPTION OF THE INVENTION

Commercial personal grooming services for hair maintenance and replacement in the invention include but are not limited to:

1) Client assessment of general health, specific diagnoses and conditions, medications, nutrition status, condition of the scalp and cutis, personal and family medical history, grooming practices, products and processes.
a. Detailed history accounting and documentation
b. Extensive physical examination
c. Counseling, education and practical training
d. Mutually defined specific goals, strategies and methods to achieve them
e. Key performance metrics, milestones and timelines
f. Plan revision to optimize benefits as results are assessed.

2) Grooming services history of cutting, treatments, products and practices.

3)Maintenance, enhancement and optimization of the client's remaining hair .
a. Topical therapies over-the-counter and by prescription
b. Pulsating light therapies
c. Grooming instruction and practice
d. Nutrition programs
e. Massage and physical therapies

4) Hair replacement if agreed upon to meet the specific styling, lifestyle and preferences of the client.
a. Analysis of the client's cutis
   i. Reflectance and the presence/rate of graying, alopecia areata, albinism, inflammation, genomics and shingles and infestation
   ii. Exposure to contaminants, environmental, pharmaceutical products
   iii. Balding, patterns, shedding rates and volume, diffuse or local, traction trauma
b. Mapping of client's hair wave, density, whorl, pattern, streams, flexibility (twists, curls or knots), texture touch and color (melanin, types eumelanin (dark) and/or phaeomelanin (light)) gradations
   i. Racial type, length, thickness and weathering/tip wear (natural and product damage), glossiness, elasticity and static electricity
   ii. Moisture/oil content, shaft diameter/shape, porosity, cuticle, and cortex metrics; fragility and strength
   iii. Distribution of keratin, follicle and hair bulb characteristics, curve, and twist rates over length distribution
c. Defining the area to be replaced
   i. Fitting the replacement system base to the specific contours of the skull or correcting deficits in the skull as well as the color of the scalp.
d. Selecting the rate of replacement
e. Choosing multiple (four to six) colors of natural culturally indigenous (consistent genetic origin) hair to populate the hair replacement system with
f. Populating the hair into the replacement system strand by strand matching the characteristics found in the above sub-step b.

The invention provides a comprehensive intervention program with quality assurance methods that engage the client in the process of establishing goals, practices and performance/outcome indicators and program compliance.

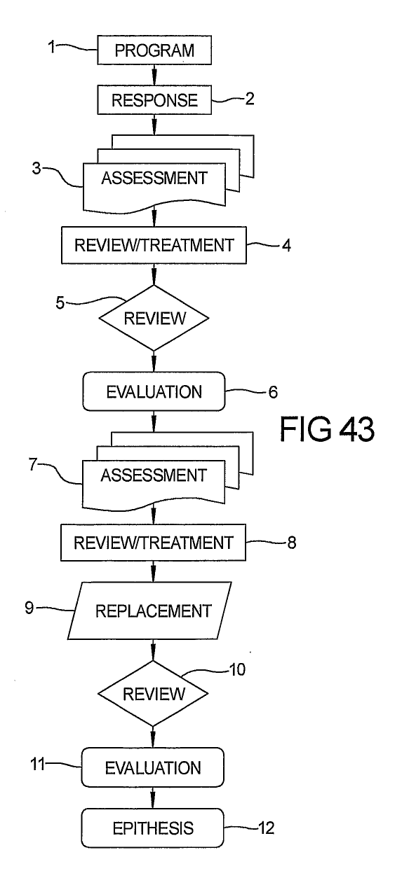

With reference to the overall process flowchart shown in FIG. 43: Program step 1 represents a marketing program for hair maintenance or replacement; Response step 2 represents the client responding to the marketing program; Assessment step 3 represents a Tricotest™ computerized assessment of the client's hair and scalp; Review/Treatment step 4 represents a review of the results of step 3, consultation and treatment plan recommendations, topical therapies (home/salon treatment modalities, e.g., massage, steam/ozone, laser/light-pulsed electrical field stimulation), and type, duration, intensity and frequency of such therapies; Review step 5 represents client assurance, review, and decision, and making a review and decision card or other record; Evaluation step 6 represents an interim evaluation of results and quality, and the client reviews progress with a stylist and a technician, and the treatment plan is modified as necessary and/or continued; Assessment step 7 represents a further TricotestTM computerized assessment of the client's hair and scalp; Review/Treatment step 8 represents a review of the results of step 7, a detailed plan of ongoing program of either styling only, styling and hair maintenance, or maintenance and replacement program, and consultation and treatment plan recommendations, topical therapies (home/salon treatment modalities, e.g., massage, steam/ozone, laser/light-pulsed electrical field stimulation), and type, duration, intensity and frequency of such therapies; Replacement step 9 represents that the hair replacement process begins with detailed assessment of immediate or gradual replacement, length and style goals, physician assessment is completed, measurement for Bicast and Calco is made, and sent to production facility with work order and contract, an maintenance program continues with Epithesis completion; Review step 10 represents client assurance, review, and decision, and updating of the review and decision card or other record; Evaluation step 11 represents a further interim evaluation of results and quality, and the client reviews progress with a stylist and a technician, and the treatment plan is modified as necessary and/or continued; and Epithesis step 12 represents that the Epithesis is delivered, applied and service is scheduled for every three weeks as client reviews progress with stylist and technician, and the treatment plan is modified as necessary and/or continued.

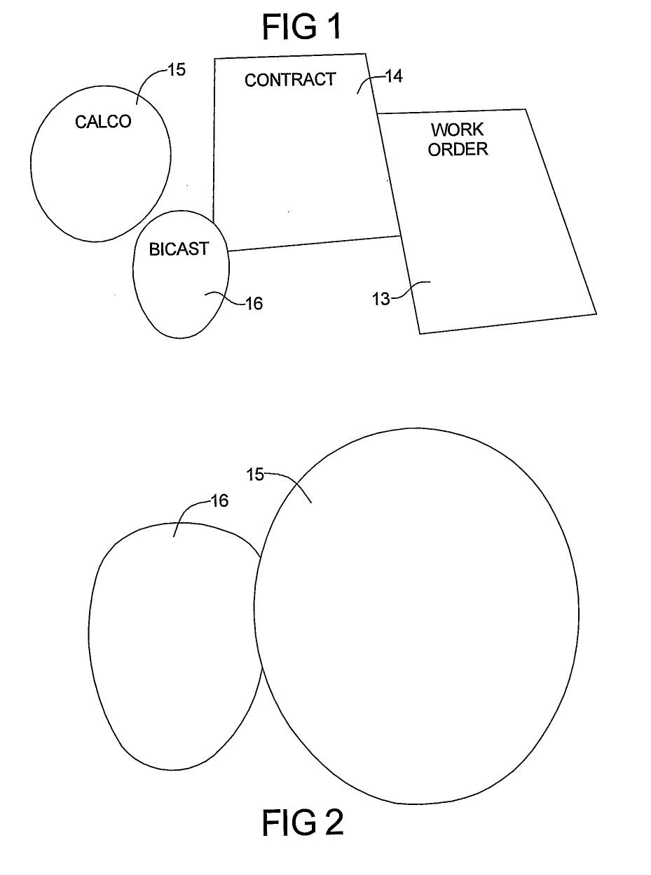

In the production facility each task is clearly defined and orderly in its steps and location as it fits into the seamless production of the hair replacement system. The production facility receives a work order 13 (FIG. 1), a contract 14, and impression of the client's skull or Calco 15, and of the area for hair replacement or Bicast 16, a set of both pieces is made for each Epithesis or hair replacement piece 17, and a client will most often have more than one. The Calco 15 is a negative mold made of fiber or plaster molded in the salon of the client's head and is used to make a positive head mold which is used to place the Epithesis 17 on. The work order 13 contains vital information from the client including hair/scalp color, percentage of gray, density, style, length, and more all of which are used to make the Epithesis 17. The contract 14 is included to ensure the continuity and completeness of each order.

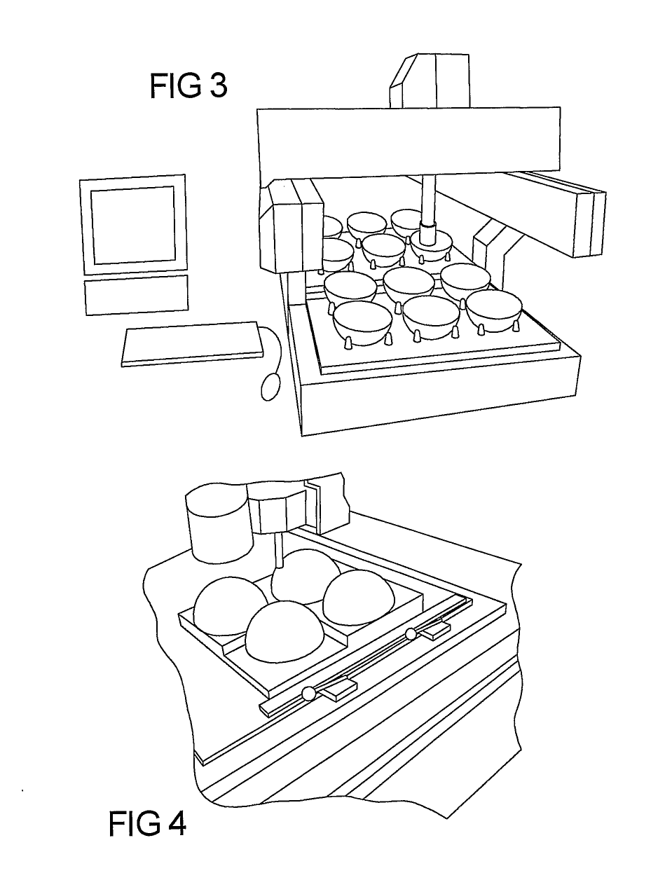

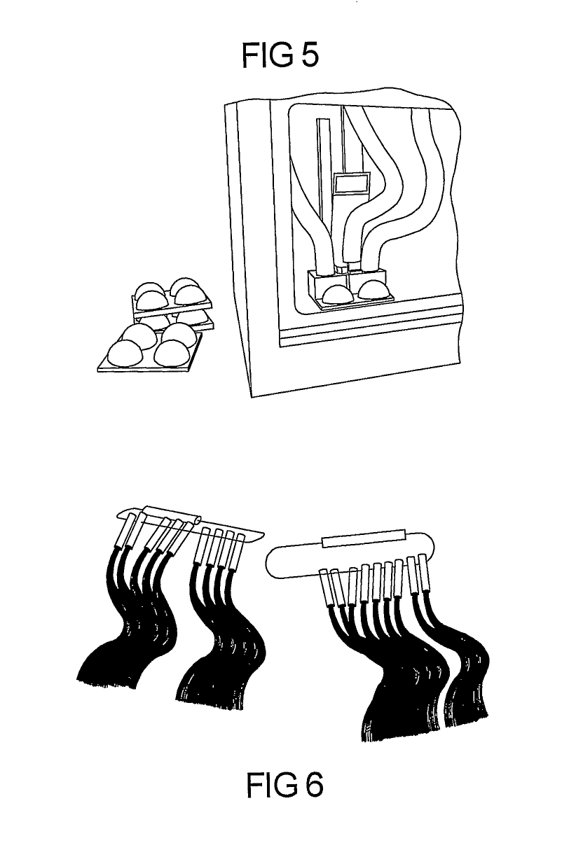

Within the inside of the negative Calco 15 the outline of the Bicast 16 is traced in precise placement and is transferred to the positive head model (FIG. 2). The production from the Calco negative to a positive is made by a computerized machining system (FIGS. 3-5).

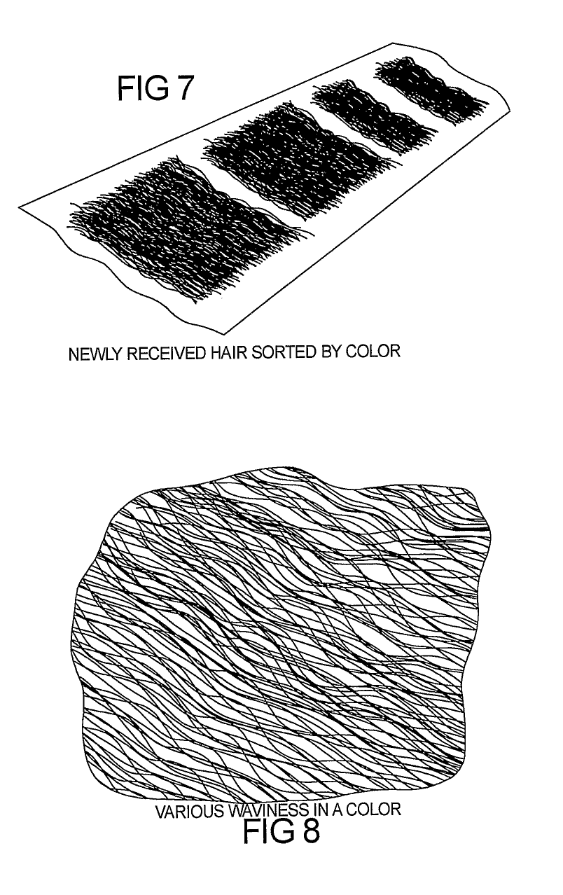

While hair color and gray percentage is selected at the salon at the production facility it is confirmed and a mixture of hair meeting the specification is made (FIG. 6). The hair is delivered to the production facility, and cleaned and sterilized in a banded pony-tail like manner. It is inspected and sorted to length by experienced hands and ends up making several groups by length from a single initial package (FIGS. 7-10).

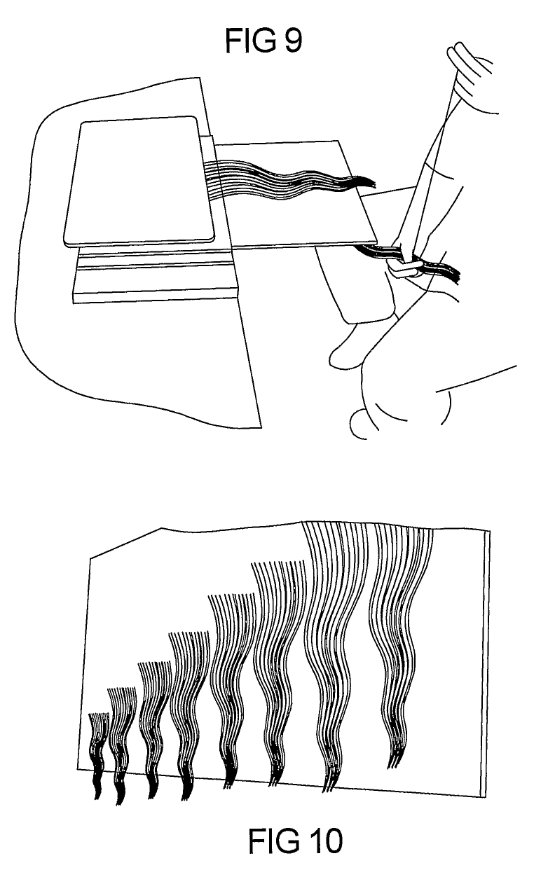

The receipt of hair varies not only by color and percent of gray but also by degree and type of waviness and race (FIGS. 7 and 8).

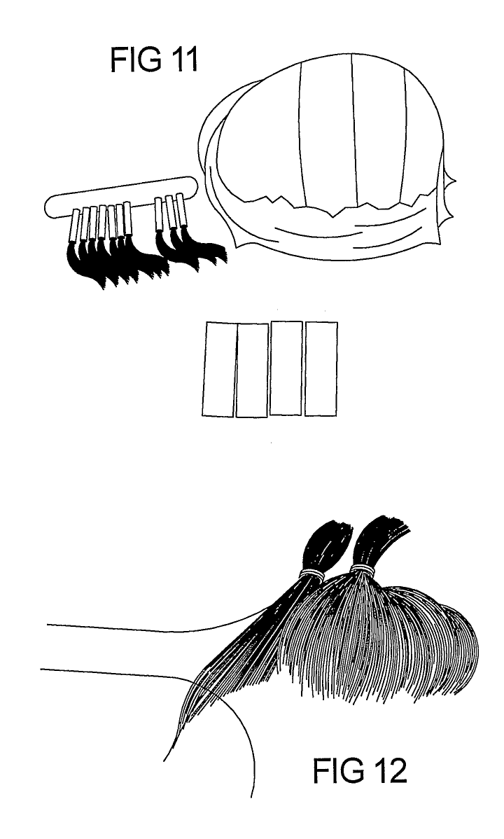

Next the client's Bicast mold is transferred into a color specific bi-layer surgical plastic mold fitted to the size of the replacement area that becomes the Epithesis 17 (FIG. 11). The plastic type is based upon the client's skin color and sensitivity.

The hair is carefully selected and its directionality is tested and maintained, because if directionality is mixed when the hair is washed, hair in the wrong direction ruffles and turns into a tangled “birds nest” like appearance (FIG. 12).

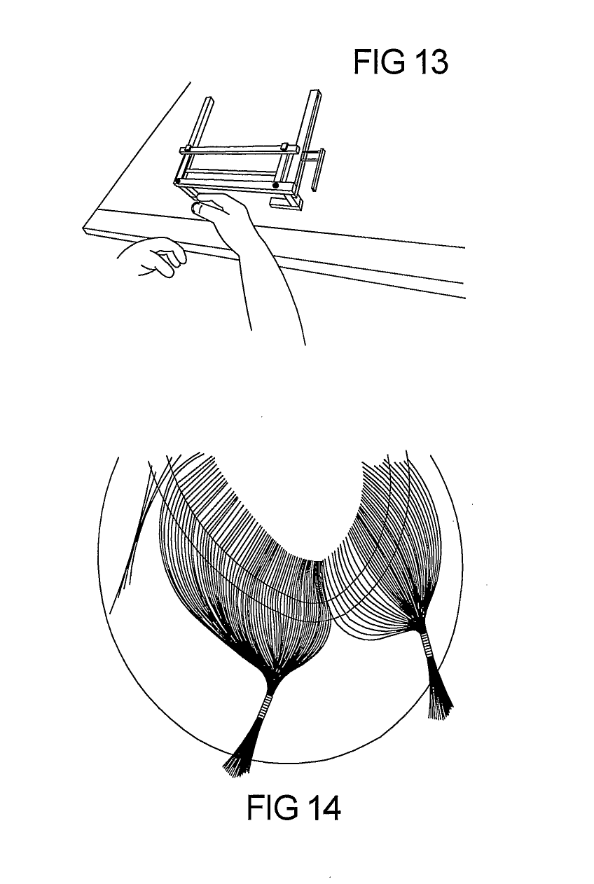

The border preparation step is especially important as whether the client has natural hair with the Epithesis 17 behind it or if the Epithesis 17 will be first seen the margins must be carefully blended to ensure natural appearance. First the hair is sorted and placed in a laser cut single hair row device to provide individual hair separation and balance (FIG. 13).

Initial placement in the Epithesis 17 is made and the row secured into the molded margin (FIG. 14). The process is labor intensive with each hair placed carefully and individually, and the process to build an Epithesis 17 takes considerable time.

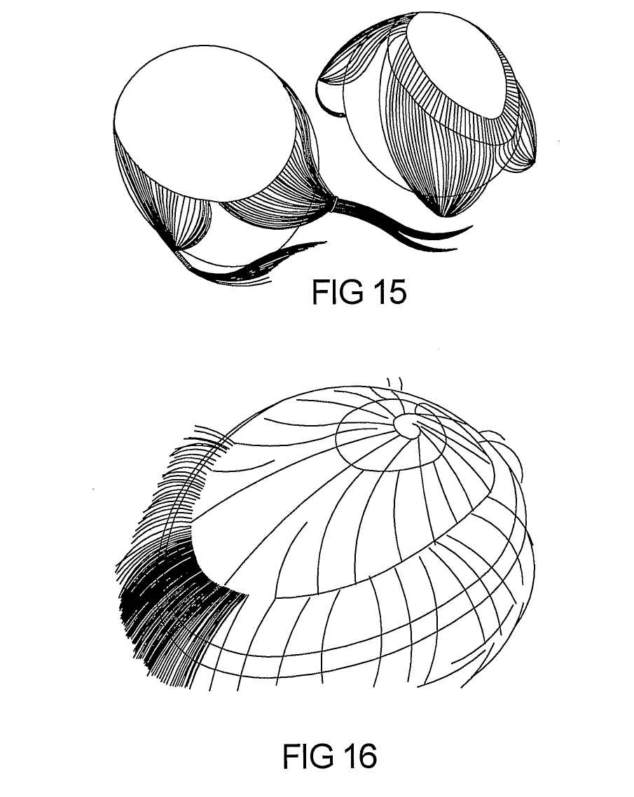

Then another layer of surgical plastic is adhered to form a more robust and secure placement base for the hair (FIG. 15).

Then the wave beginning or whorl of the client, and the client's overall individual wave form is plotted on the Epithesis 17 to ensure continuity of the natural look of the client as the technician inserts each hair individually to populate the Epithesis to the exact contours of the client's head (FIG. 16).

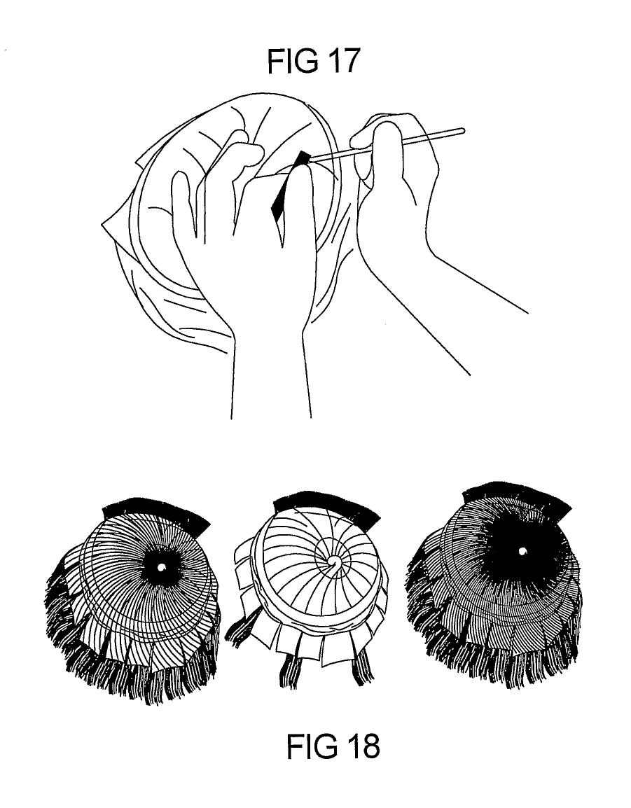

At this point individual hair insertion proceeds (FIG. 17) and is continued to populate the entire scalp. Careful attention is made to ensure that the angle of each hair is placed not only in the wave/whorl pattern but to maintain directionality for a natural response to wind, water and activities the client may encounter. The Epithesis is a natural hair replacement system that carries and maintains the client's tricological persona and identity.

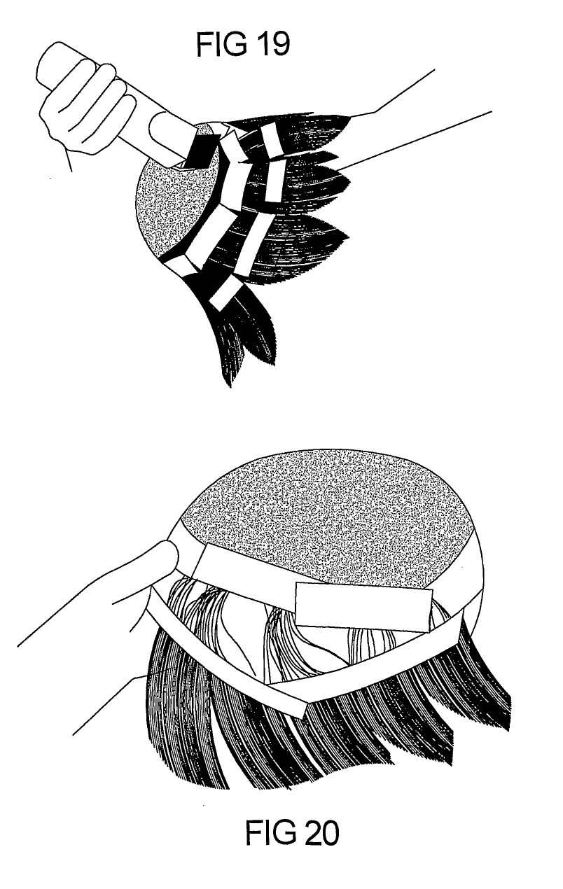

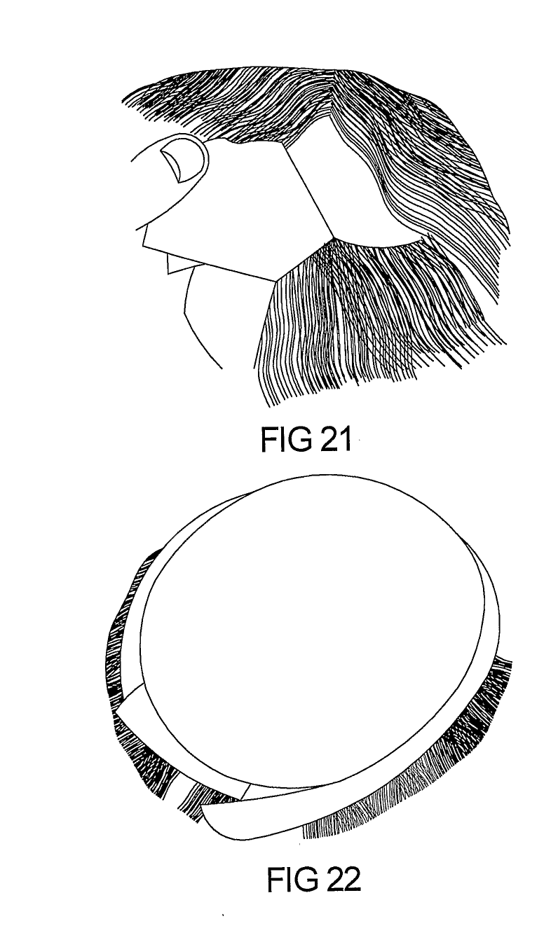

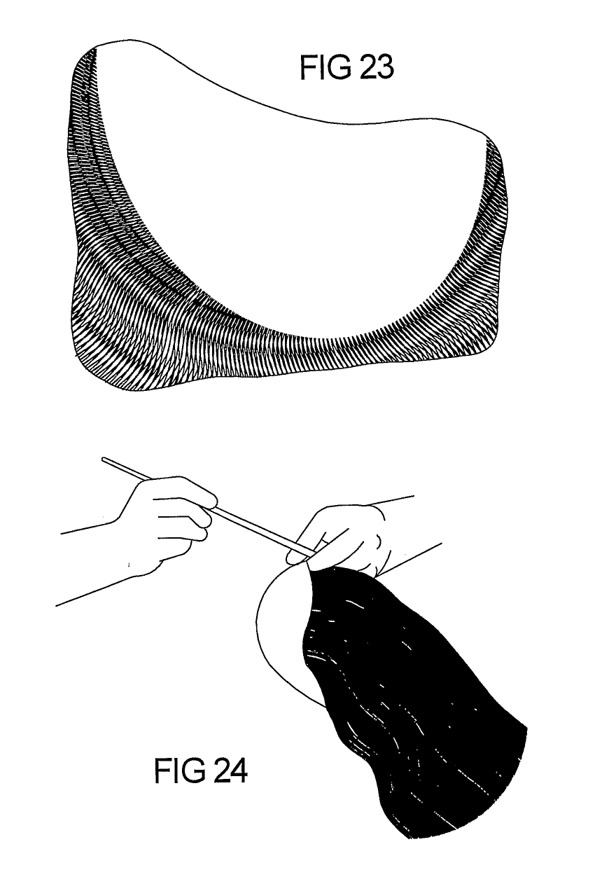

Once populated, the hair system is reversed and the interior trimmed to receive the final surface care, and FIGS. 18-24 illustrate that process.

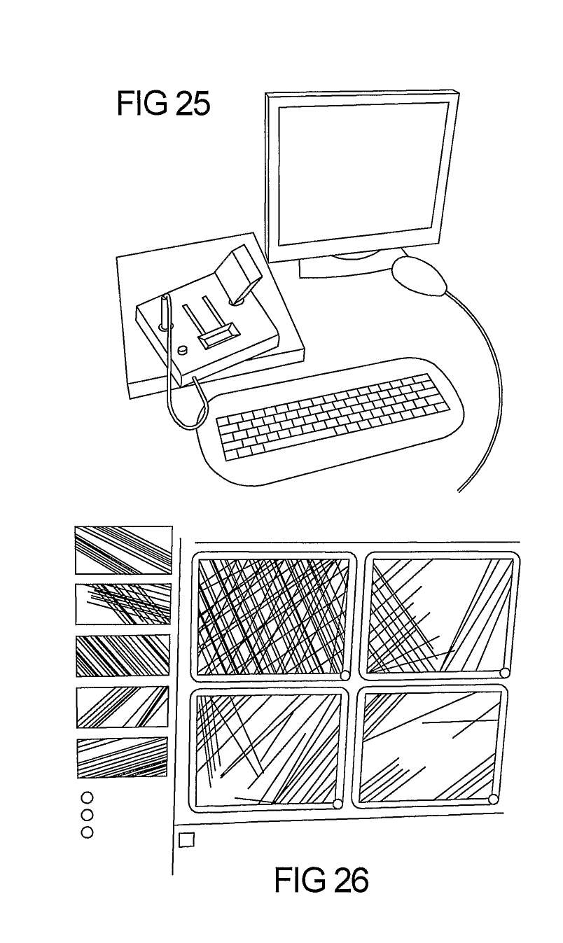

At the salon the client completes a specialized assessment of scalp and hair using the Tricotest™ system (FIG. 25) which performs a computerized systematic measure of the color, character, health, density, wave and style of the client, as well as levels of sebum, hydration and pH.

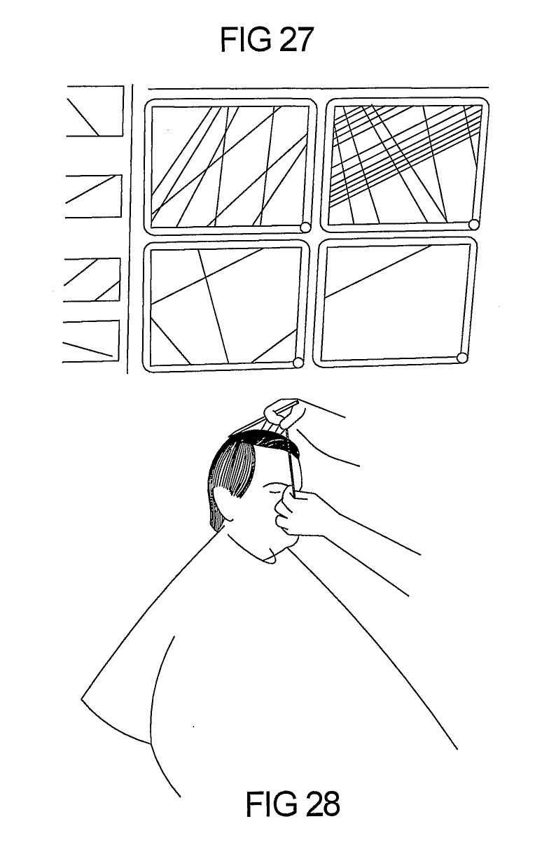

The assessment results are computerized and available for reference and comparison over time to demonstrate the effects of hair maintenance and therapies (FIGS. 26 and 27).

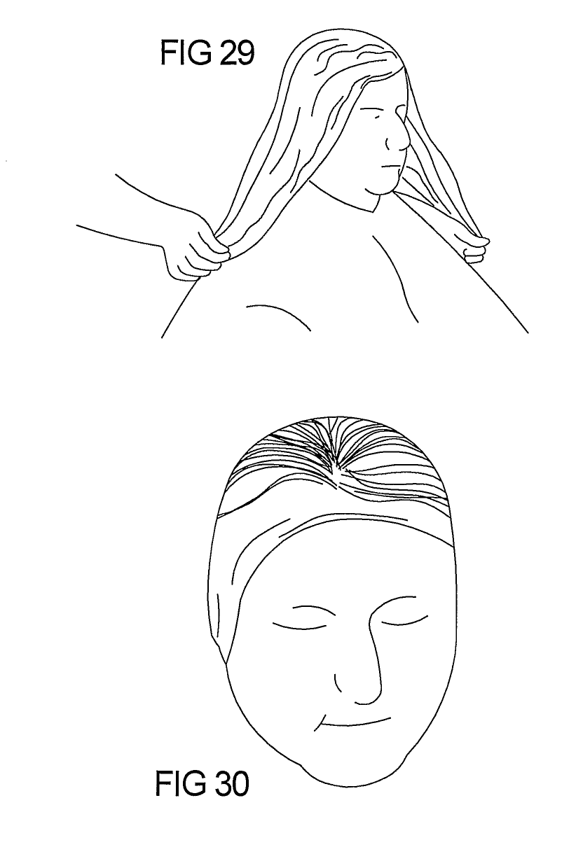

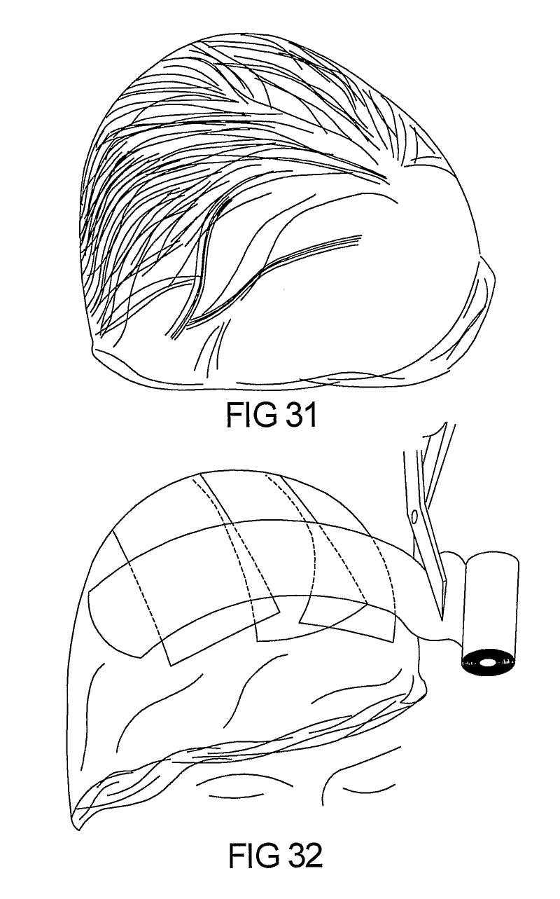

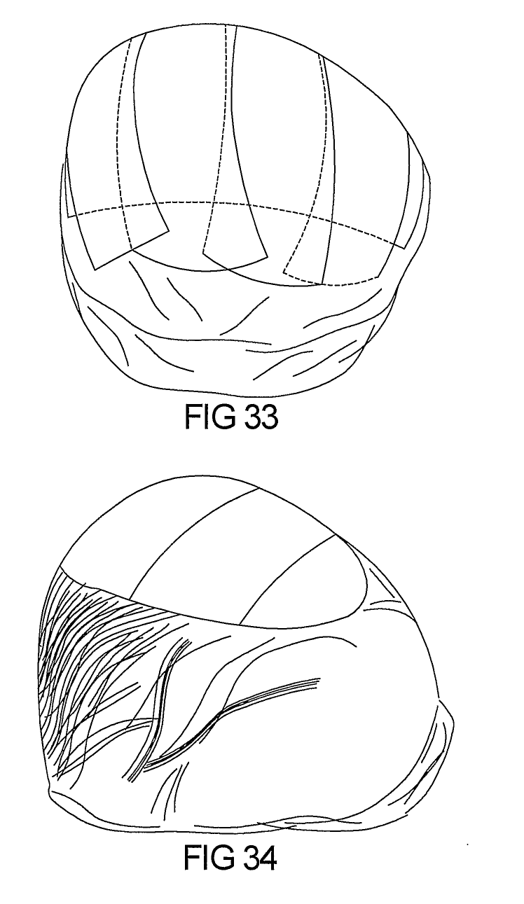

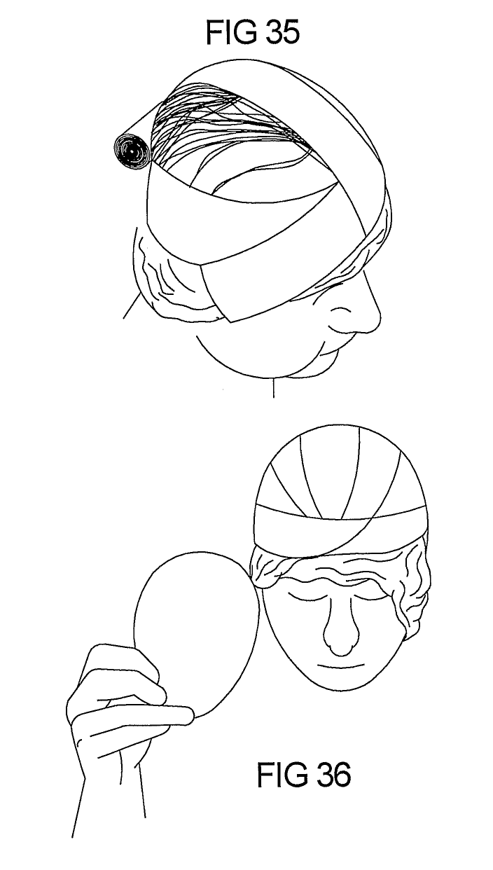

FIGS. 28-37 demonstrate the process in the salon of making the impression of the Bicast and Calco. Careful attention is taken to ensure form fit to the client's skull and outline of the area of hair to be replaced.

The client's remaining hair is wetted to ensure its flattening and conformation to the skull. Surgical plastic is molded to the client's head and fastened to protect the hair and head as the mold is made and formed.

Once the completed Epithesis 17 is returned to the salon, the client's scalp in the area of the replacement is prepared by trimming the remaining hair to the scalp. Then the Epithesis is fitted and checked; once confirmed the Epithesis is adhered to the client's scalp with the specific surgical adhesive selected through the skin-testing performed by the licensed physician and board-certified dermatologist. Next the client's hair is styled to the length of the Epithesis chosen, remembering that some clients may utilize a sequence of systems to provide a gradual replacement of hair.

At intervals the client returns to the salon for servicing; generally about every three to five weeks when the Epithesis 17 is removed, the newly-grown remaining hair is trimmed, the scalp is treated, massaged and such, and then a newly-serviced Epithesis is replaced as described and the client's hair is styled once more.

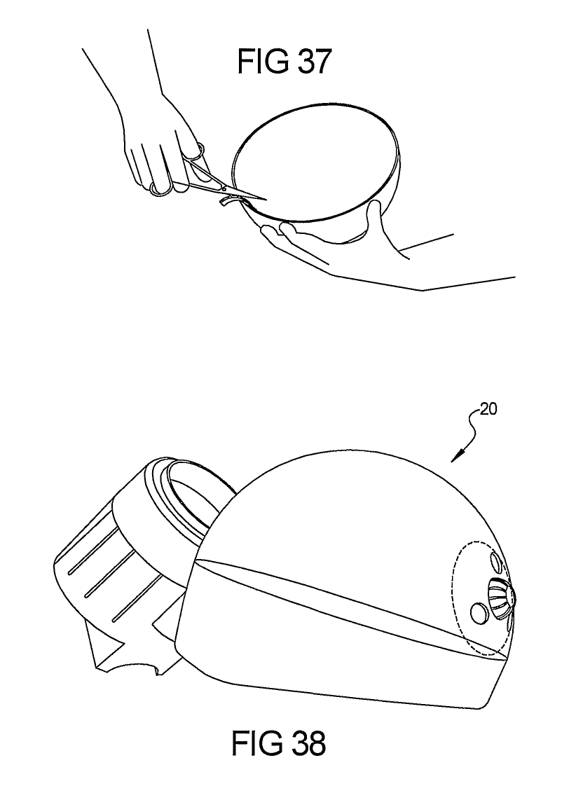

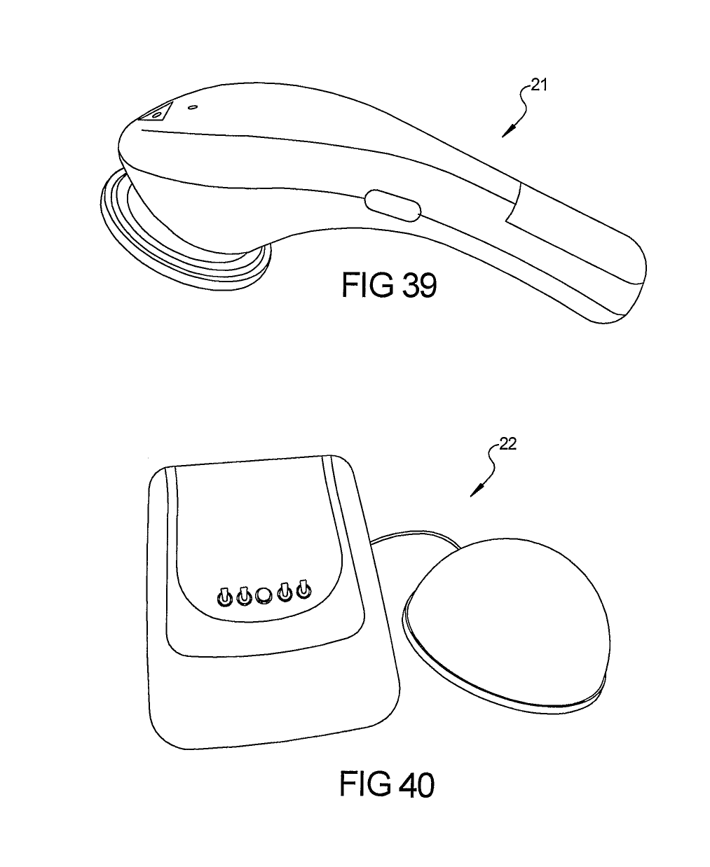

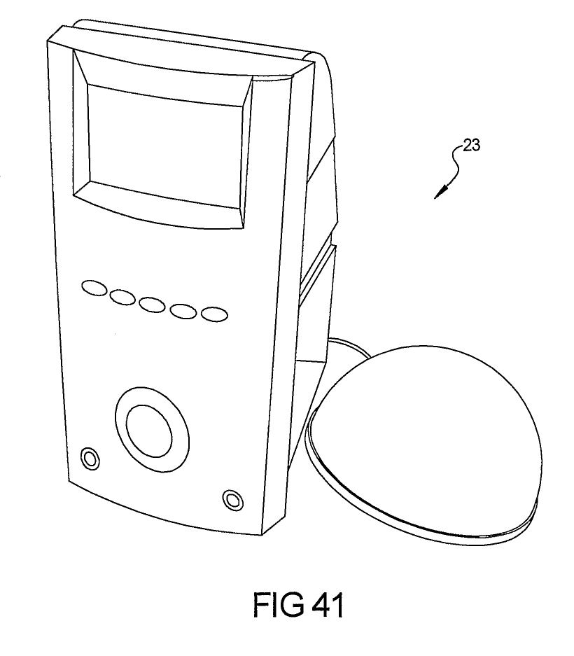

With reference to FIG. 38, the Vapoozono™ device 20 is a special hairdryer which combines the beneficial effects of steam with the disinfecting action of ozone. Steam dilates the pores, thus helping the penetration of the applied product. It has a detox action while the ozone brings the bacterial flora to its original balance.

With reference to FIG. 39, the Tricopulse Special™ device 21 is a portable laser/light device for personal use for photo stimulation of the scalp by means of a dual spectrum, high intensity light beam generated by a matrix of 18 LED's. The light treatment features pulsed emission of beams of light in the red and violet spectrums. The violet light promotes the reduction of bacterial load, while the red spectrum enhances microcirculation.

With reference to FIG. 40, the Tricopulse Professional™ device 22 is a laser/light device for professional salon use for photo stimulation of the scalp by means of a dual spectrum, high intensity light beam generated by a matrix of 126 LEDs. The light treatment features pulsed emission of beams of light in the red and violet spectrums. The violet light promotes the reduction of bacterial load, while the red spectrum enhances microcirculation.

With reference to FIG. 41, the Tricopulse ETG™ device 23 is an electrostatic treatment device which stimulates follicle and hair growth. The electrostatic stimulation increases peripheral microcirculation boosting the carrier function of the blood. A treatment cycle using the Tricopulse ETG™ device generates regrowth and reduces hair loss in 96% of persons treated.

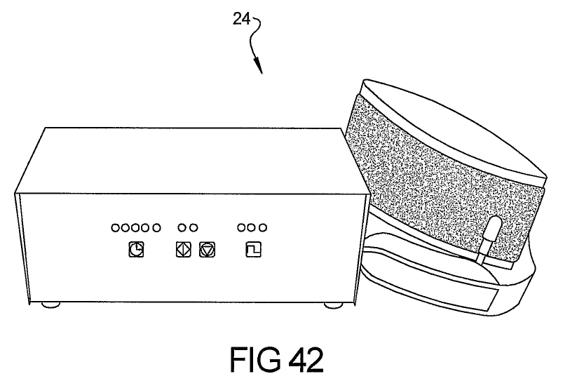

With reference to FIG. 42, the Tricopress P1us™ device 24 is an instrument which provides an efficient and pleasant massage of the scalp with firm and elasticizing action. The treatment improves blood circulation and preserves the skin elasticity, thus helping the penetration of the applied product.

Changes, modifications, variations and other uses and applications which do not depart from the spirit and scope of the invention are covered by and embraced within the invention and the claims set forth below.

1. A business method for providing quality services which providers and clients will comply with and deliver consistent and reproducible hair maintenance and/or replacement services, comprising the steps of:
conducting a hair maintenance and/or replacement marketing program;
first assessing a client, who has responded to said marketing program, using a computerized system which measures color, character, health, density, wave and style of the client's hair and scalp as well as level of sebum. hydration, and pH;
reviewing results of said computerized system assessing step;
first consulting with the client and recommending a treatment plan including type of treatment, duration, intensity, and frequency selected;
first treating the client's hair and scalp with procedures selected from a group comprising topical therapies, massage, steam/ozone, laser/light, and pulsed electrical field stimulation;
preparing a client assurance review and decision record;
first interim evaluating results and quality;
first reviewing progress with client, stylist, and technician;
continuing or modifying said treatment plan as necessary;
second assessing of the client using said computerized system which measures color, character, health, density, wave and style of the client's hair and scalp as well as level of sebum. hydration, and pH;
reviewing results of the computerized system second assessing step;
planning ongoing program of either styling only, styling and hair maintenance, or hair maintenance and replacement program;
second consulting with the client and recommending a further treatment plan including type of treatment, duration, intensity, and frequency selected; and
second treating the client's hair and scalp with procedures selected from a group comprising topical therapies, massage, steam/ozone, laser/light, and pulsed electrical field stimulation.

2. The method according to claim 1, including the steps of:
beginning hair replacement program with detailed assessing of immediate or gradual hair replacement, length and style goals, and assessing by physician;
measuring for a Bicast and a Calco;
sending the Bicast and Calco measurements to a production facility with work order and contract; and
continuing maintenance program to substantially coincide with completion of an Epithesis for the client.

3. The method according to claim 2, including the steps of:
updating said client assurance review and decision record;
second interim evaluating results and quality;
second reviewing progress with client, stylist, and technician;
continuing or modifying the treatment plan as necessary;
delivering said Epithesis and applying it to the client;
scheduling Epithesis service for every three weeks as the client reviews progress with stylist and technician; and
continuing or modifying the treatment plan as necessary.

4. The method according to claim 1, including the step of:
photo stimulating the client's scalp.

5. The method according to claim 4, wherein:
said photo stimulating step includes pulsed emission of beams of light in red and violet spectrums.

6. The method according to claim 5, wherein:
said pulsed emission of beams of light in said red spectrum enhances microcirculation; and
said pulsed emission of beams of light in said violet spectrum promotes reduction of bacterial load.

7. The method according to claim 4, wherein:
said step of photo stimulating the person's scalp is performed by means of a dual spectrum, high intensity light beam generated by a matrix of a plurality of LED's.

8. The method according to claim 5, wherein:
said step of photo stimulating the client's scalp is performed by means of a dual spectrum, high intensity light beam generated by a matrix of a plurality of LED's.

9. A comprehensive method of maintenance and/or replacement of a client's hair, comprising the steps of:
evaluating general health, specific diagnoses and conditions, medications, nutrition status, condition of scalp and cutis, personal and family medical history, grooming practices, and products and processes used by the client;
ascertaining grooming services history of cutting, treatments, products and practices used by the client;
maintaining, enhancing, preparing, and optimizing the client's scalp and remaining hair;
replacing hair, if agreed upon by the client, to meet specific, styling, lifestyle and preferences of the client; and
performing maintenance of the replacement system.

10. The method according to claim 9, wherein:
said maintaining, enhancing, preparing, and optimizing the client's scalp and remaining hair includes one or more treatments selected from a group comprising massage, steam/ozone therapy, electrostatic treatment, and photo stimulation.

11. The method according to claim 10, wherein:
said evaluating step also includes measuring hydration, sebum, pH, hair shaft thickness, hair density (number of hairs per square centimeter), hair shaft keratin content, scalp condition, dandruff, and inflammation.

12. The method according to claim 11, wherein:
said steam/ozone therapy comprises a stand-alone modality which promotes absorption of oils, dandruff remedies, and a TricosilTM product line, circulation, and restores a balance of natural flora.

13. The method according to claim 9, wherein:
said step of performing maintenance of the replacement system includes hair maintenance treatment with predetermined products which promote scalp health and hair thickness; and
said predetermined products comprise oils, dandruff remedies, and a TricosilTM product line.

14. The method according to claim 9, including the steps of: measuring the client's hair replacement area in proportion to the client's face shape, length and width;
using casting materials to fabricate a Bicast mold of said hair replacement area which is where an Epithesis for the client is placed; and
using a mold of the client's entire skull to support style, overall design, and provide a portable head to place hair pieces on.

15. The method according to claim 14, wherein:
said Epithesis is fabricated by a custom application which includes strand-by-strand placement, predetermined angles of each said placement, predetermined density of said placement, and a predetermined pattern of said placement.

16. The method according to claim 12, wherein:
said step of performing maintenance of the replacement system includes hair maintenance treatment with predetermined products which promote scalp health and hair thickness; and
said predetermined products comprise oils, dandruff remedies, and a TricosilTM product line.

17. The method according to claim 16, including the steps of:
measuring the client's hair replacement area in proportion to the client's face shape, length and width;
using casting materials to fabricate a Bicast mold of said hair replacement area which is where an Epithesis for the client is placed; and
using a mold of the client's entire skull to support style, overall design, and provide a portable head to place hair pieces on.

18. The method according to claim 17, wherein:
said Epithesis is fabricated by a custom application which includes strand-by-strand placement, predetermined angles of each said placement, predetermined density of said placement, and a predetermined pattern of said placement.

19. A comprehensive method of maintenance and/or replacement of a client's hair, comprising the steps of:
assessing general health, specific diagnoses and conditions, medications, nutrition status, condition of scalp and cutis, personal and family medical history, grooming practices, and products and processes used by the client;
ascertaining grooming services history of cutting, treatments, products and practices used by the client;
maintaining, enhancing, and optimizing the client's remaining hair; and
replacing hair, if agreed upon by the client, to meet specific, styling, lifestyle and preferences of the person.

20. The method according to claim 19, wherein:
said hair replacing step comprises sub-steps of :
analyzing the person's cutis;
mapping the person's hair wave, density, whorl, pattern, streams, flexibility (twists, curls, and/or knots), texture touch and color gradations;
defining an area or areas to be replaced;
selecting a rate of replacement;
selecting multiple colors of natural culturally-indigenous hair to populate said area or areas to be replaced; and
populating hair into said area or areas to be replaced strand by strand to match characteristics found in said mapping sub-step.
